(19) United States
(12) Patent Application Publication
(10) Pub. No.: US 2002/0007483 A1
(43) Pub. Date: Jan. 17, 2002

(54) Interactive flow visualization, graphical editing and analysis of textual languages

(76) Inventor: Luis R. Lopez, Owens Crossroad, AL (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 09/783,880

(22) Filed: Feb. 12, 2001

Related U.S. Application Data
(63) Continuation-in-part of application No. 08/790,084, filed on Jan. 29, 1997, now abandoned.

(51) Int. Cl. G06F 9/44

(52) U.S. Cl. 717/3

(57) ABSTRACT

This invention is a method for creating systems that support visual editing and manipulation of arbitrary (any language) textual source code as graphical flowcharts. The cornerstone of this invention is a textual Flow Structure Markup Language (FSML) that encodes algorithmic flow information representing the logical procedural intent of a file (or files) of textual code. The FSML can be placed within a file containing both text source code and FSML encoded flow information, or in parallel as a secondary file that stores the flow information, or as an attribute in a database record wherein each record can also contain a single procedural instruction of the procedural language or reference therein. In all embodiments the flow information is synchronized with the text code instructions so that each line, or instruction of text code, has a corresponding line, tag, or identifying mark that denotes, or encodes, the type of flow that a text code instruction represents.

### CROSS REFERENCE TO RELATED APPLICATIONS

This Application is a Continuation-in-part of and claims priority to the Application filed on Jan. 29, 1997, Ser. No. 08/790,084 titled “Methods and Apparatus for Interactive Parsing and Visual Representation of Arbitrary Textual Languages for Structured, Graphical Editing and Manipulation of Text Code as Flowcharts.”

### FIELD OF THE INVENTION

The present invention relates to the field of efficient manipulation of any textual source code and system configuration file. In particular, the invention relates to generalized graphical representation and manipulation of all computer software programming languages. More particularly, this invention relates to a specialized application of language markup notation and related methods for automatically enhancing existing textual software code with flow-based information and graphics; to the manipulation of the flow-based graphics that results in automatic manipulation of the original source code; and to the creation of all-language software flow charters, translators, analyzers and code browsers that function equally well on any computer source code language that can be reduced to a text file.

### BACKGROUND OF THE INVENTION

Visual programming is a fast growing technology that enables software developers to produce higher quality software in less time than previous methods have allowed. The most common technique for visual programming known to the art is to use a What You See Is What You Get (WYSIWYG) graphical interface to visually design buttons, menus, and other Graphical User Interface (GUI) software components. The current art is to then generate, transparent to the user, a software component that implements the said GUI layout. It is then up to the programmer to enter instructions to define and associate actions with each GUI element that may produce an action, such as the pressing of a button. These instructions are in the form of textual code, typically written in some programming language such as Java, C++, ADA, BASIC or a System Definition Language (SDL). Many visual programming systems in use today will automate a limited set of software development tasks using WYSIWYG graphical interface methods. Eventually the programmer is required to enter logical and procedural instructions to define specific actions for the software system under development. The existing art is to place the programmer in a textual code editor—similar to a word processor—wherein the programmer must type textual code to define the software's behavior. Procedural instructions of textual code in some computer language are then entered, primarily using a keyboard or other text entry device, as textual characters on multiple lines.

Known to the art are visual queues that aid the editing of the text itself. Said queues relate to enhancing the layout, readability and format of the textual code with respect to a text editor such as:

text coloring based on language syntax, and;

text code “pretty printing,” or automatic indentation based on syntax;

code folding—a method for automatic syntax-dependent outlining.

The key problems with these techniques is that they do not completely eliminate the programmer's need to edit textual code in a word processor and do not provide a visual means for displaying the program flow graphically while editing. Furthermore, it provides no means to allow the programmer to edit the flow of the programming without understanding the details of the language's specific flow-oriented instructions. Procedural code development is still accomplished using a word processor in almost 100% of any software development using the current art.

With little, or no visual guidance, the quality of the typed procedural code will be a function of how well its author can visualize the process she, or he, is encoding, and to the extent that the programmer can keep track of multiple nested levels of a language's specific flow-oriented instructions. This makes the current art for procedural code development much harder to accomplish error-free and is likely to result in syntactic and logical errors. The current state of the art in visual programming does not yet provide methods, nor apparatus, for concurrent structured flow visualization and editing of textual code that can be applied to all computer languages.

Much software today—hundreds of millions of lines if not billions of lines of code, e.g. instructions, is obsolete, yet cannot be easily modernized due to the extreme difficulty and expense required to understand and reengineer old software. In part, this is due to the poorly understood and implemented engineering practices that have been used, and still are prevalent, in the field of software engineering. Additionally, most programmers today are not well versed in older computer languages and consequently cannot efficiently grasp the flow-oriented instructions of old code. Knowing how the flow-oriented instructions of source code define its logical process is critical in understanding what a section of source code accomplishes. A similar argument can be made in the case of learning a new programming language. Until a programmer is comfortable in deciphering the flow-oriented instructions, he/she is lost in understanding the code.

Current practice in software engineering includes the use of Computer Aided Systems Engineering (CASE) tools that also employ visual programming techniques. The details of applied CASE methodologies can vary. Typically, a CASE tool will graphically specify a system diagram defining the architectural level using a set of linked objects. This system architecture can then be used to automatically generate textual code for the said system based on the architecture. CASE tool users are sufficiently skilled in the art to reverse engineer the design of a system from the source code and produce a visual architecture specification of the system as well. Still, the largest problem with re-engineering this way is that if the older system was not developed with good programming practice, the architecture diagrams derived from a CASE tool are of limited utility. In order to completely re-engineer a poorly built system, many of its parts will have to be deciphered at the procedural level—not the architectural level. This involves a great deal of programmer labor that cannot be avoided.

Another problem with the state of the art CASE method is that it tends to have similar limitations that are present in the “visual programming” art. Specifically, visual CASE tools utilize graphical editing and code generation to create a software system at a higher architectural level. These tools tend to fall back on text code editing when detailed functionality must be developed. CASE tools provide few alternatives when a programmer must customize and “fine tune” a system. The primary method is to place the programmer in a text editor along with CASE tool generated code. Since the programmer must then the type additional source code instructions to provide customized functionality this method can introduce software bugs. Although widely used, this method is fraught with a higher probability of error and departs from the overall graphical nature of modern CASE tools and visual programming. Even when the code changes are error free, it is possible for the CASE tool “blueprint” and the actual software code to become desynchronized, thereby limiting the CASE tool's utility.

An alternative offered by some CASE tools provides a flowchart view, and at times a flowchart editor, to help the programmer specify the procedural details needed in a design. This method is not completely general as in the invention of this disclosure and can also lead to desynchronized source code and CASE tool “blueprint” if a programmer edits code in a text editor not supported by the CASE tool.

Another technique known in the art is to graphically construct a flowchart diagram based on a computer language independent description of a process, i.e., a System Definition Language (SDL). The process flowchart diagram can be graphically edited and used to generate textual code in a variety of target languages. Some key problems with this technique are:

it cannot be used on all existing textual programs without first reengineering the textual programs;

it may not generate textual code that is easy to understand or modify;

the programmer will be required to learn another language;

the programmer may have to draw flowchart diagrams;

by design an SDL flowchart editor is limited to a subset of languages it is able to generate and not as general as the methods taught herein

Yet another technique known in the art of flowchart programming relates to methods that focus on a particular language. These methods build a flowchart from source code directly and are very similar in function to the invention, yet do not utilize the key feature of the invention—a Flow Structure Markup Language designed for supporting all types of procedural source code. These techniques will parse text code in the said language and automatically draw a flowchart that visually depicts the procedural intent of the textual code. Furthermore, it is known to the art that a parsed language-dependent flowchart can be graphically edited and then the altered flowchart can generate an altered textual code file. A key problem with this technique is that it does not apply to all text code languages equally well. For example, one cannot apply this technique to an arbitrary pseudo code language as well as one can apply to a main stream language. The current art in flowchart programming tools (known since 1966—see reference by Sutherland) depends on complex and non-portable file formats to save a flowchart file, and does not teach a method for creation of utilities that can operate on a flowchart despite the computer language it represents.

Thus, there is a need for a flowchart editing approach that greatly enhances the readability and understanding of textual code, does not require the learning of a new specification language, can be utilized much more like a traditional text editor, will work with any textual language, does not require any drawing effort by the programmer, and can be used to create a set of tools that operate equally well on a flowcharted file of code despite the source code language, i.e. “contained context”, that is flowcharted.

### SUMMARY OF THE INVENTION

It is the object of the present invention to provide a method and apparatus which allows textual source code of any type of programming language to be embedded within the FSML code with the explicit intent of making modifications to the embedded text code as a flowchart and exporting the embedded text code into a text code file suitable for a conventional language-based tool, such as a compiler or interpreter.

This invention departs significantly from the traditional state of the art in computer programming by providing a generalized method and means to support graphical flowchart program editing and navigation for any conventional programming language in existence, and can support as-yet-unknown textual computer coding languages.

Known methods for flowchart program editing have been limited to a relatively small subset of computer programming languages, and each known method is only able to function on a few specific and limited language domains at a time, this invention provides a completely general method for supporting any and all computer languages that can be reduced to a textual file of source code. The essence of this invention's departure from the current state in flowchart based programming is that it is a method that enables the creation of generic visual flowchart programming tools that can be used on all computer languages equally, with little or no modification. Hence, the invention herein enables flowchart editing on all computer languages without limitation and with automatic and transparent updates to the underlying source code and/or the flowcharts when the code is changed. This is quite unlike any state of the are CASE tool or visual programming tools discussed in the prior art.

Furthermore, this invention herein is not concerned with the limitations associated with graphically constructing a flowchart based on a computer language independent description of a process, i.e., the SDL, since it derives its flowchart and meaning by the language that it is used on and how a user desires the graphical representation of his/her language to appear. For instance, the flowcode methods allow for arbitrary assignment of certain procedural types towards different syntactical uses. This allows a flowcode diagram (the invention's version of a flowchart) to represent a variety of different source code instructions using the same diagrammatic markups and rendering. An example would be the diagram of a logical set of paths would look very similar to the diagram of a set of parallel execution paths. The only difference may be the ‘context’ of the diagram. The ‘context’ is of course the source code language ‘contained’ within the diagram and can be referred to as ‘contained context.’

This invention applies the use of flow information files and embedded flow information using Flow Structure Markup Language (FSML) grammar. It applies FSML to the greater context of computer program source code file editing, understanding, analysis and navigation, in particular to editing, manipulation, browsing, analysis and understanding of logical and functional intent in any textually encoded series of procedural instructions using a common, flowchart format.

For the purpose of this disclosure a “file” is regarded as an electronic means for storing and retrieving data and may encompass textual, binary and database files. Also for the purpose of this disclosure, the use of the terms “source code” or “computer language code” will imply that the code is reducible to a textual file. A textual file is an electronic file of data comprising of an accepted standard for encoding characters and symbols (e.g. the ASCII standard) that form a set of, or series of, procedural instructions.

Primarily, there is a small set of unique flow ‘types’ that are represented within any program flow information. At a minimum, to adequately represent useful logical process information, we must encode in the flow, i.e. flow-code or flowcode, the following types of flow instructions:

1. The beginning (input) and termination (end) of a functional group of instructions;

2. The beginning of an iteration (loop) and its scope and exit (loop end) as applied to a group of iterated instructions;

3. A logical decision point, or parallel divergence, (branch), all logical outcomes, or parallel paths, (paths), and the end of the logical scope, or parallel convergence, (branch end) where all logical paths may rejoin;

4. A mechanism to denote jumping from or termination (end) at any point in a process along with jumping to any other point (label event) within a process.

Furthermore, this invention provides a means for transparently exporting textual source code by automatically stripping away the flow information to produce code in a standard text form (equivalent to hand typed code) that is suitable for use with any existing software development tool. This enables a user to edit a flow diagram then ‘save-export’ and automatically create a source code file that will seamlessly use existing development tools, thereby avoiding to ever have to edit procedural code in a traditional text editor.

To keep a perspective on this invention we must state that the core of the invention is a methodology that employs a highly general Flow Structure Markup Language (FSML) format to solve many problems faced by product implementations for flowchart based programming today. By using an FSML in the ways taught herein, one skilled in the art, can create a new class of source code maintenance and management tools that are centered on flowchart programming. Furthermore this new class of tools will be easily applicable to all process oriented textual languages in existence today or that may be developed in the future.

All embodiments of this invention rely upon a Flow Structure Markup Language (FSML). Markup languages have become increasingly popular in the past few years due to the rise of the internet and Hyper Text Markup Language (HTML). The latest developments in this area have brought about eXtended Markup Language (XML). Definition and development of XML is predated by the initial work documented on this invention as well as the initial filing date for this invention.

Markup Languages have been in use for many years in computer science and software engineering and no one thus far has taught the methods disclosed herein to support multiple language, common format, and flowcharted source code utilities. Moreover, there is a lack of programming utilities and products that employ completely flowcharted source code for viewing and editing for all types of source code.

### BRIEF DESCRIPTION OF THE DRAWINGS

The said invention can be better understood with reference to drawings. The drawings emphasize the function of the preferred embodiment of the present invention and provide an illustration of its principle effect on textual code manipulation.

FIG. 1 illustrates the flowchart representation of a simple ‘C’ program, its original FSML listing, an XML-compliant FSML listing, and the source code;

FIG. 2 is a block diagram illustrating the basic architecture of a software code editing system that uses the main components of the invention;

FIG. 3 illustrates a one-time conversion to a flowcode system that can export a text code file and apply a language-specific tool on the exported code file;

FIG. 4 illustrates a compact system of flowcode cells and their FSML code names.

### DETAILED DESCRIPTIONS OF THE PREFERRED EMBODIMENT

In view of the foregoing, it is the objective of the present invention to combine algorithmic flow information with any textually based procedural language, and utilize an interactive parsing editor system for automatically drawing a structured, visual representation (i.e. a flowchart) of the algorithmic process intended by the textual code. A new term to describe an arbitrary text code that has been enhanced by encoding algorithmic flow information is flowcode. “Flowcode” will here after be used to refer to any arbitrarily chosen, text-reducible, source code language that is combined with FSML-encoded flow information.

The present invention also enables graphical editing of the flowchart representation and will, transparently to the user, export the textual code in a form appropriate for software development tools to accept. In other words, another objective of the present invention is to transparently and automatically export textual source code from a flowcharted view into a form that is suitable for a compiler, interpreter, or other language-specific tool to use, thereby eliminating the need to edit textual code in a ‘word processor’ type editor. A further objective of the said invention is to provide flowchart editing features to all types of textual, or text-reducible, source code languages that is complete enough to replace the traditional ‘word processor’ text code editor currently in widespread use among the computer programming industry.

To simplify the implementation and the discussion of the present invention, the following will describe the invention's use of a class of specialized languages referred to herein as Flow Structure Markup Languages (FSMLs). A FSML is a means for encoding algorithmic information in parallel with the arbitrary textual code. Using a FSML to create an apparatus in the spirit of the present invention is generally transparent to the user. Hence, the user is not required to learn the FSML. Other means for encoding algorithmic information within, or in parallel, to the textual code can be used in lieu of the exact FSML specified herein without departing from the spirit of the present invention. This invention utilizes a set of languages that are specific to code process flow encoding. There are specific properties these languages must posses to enable practicing this invention. These properties uniquely limit and identify a FSML and are presented within this detailed disclosure. Hence, the use of a properly devised eXtended Markup Language (XML) can also encompass the same flow information and contain all required FSML properties, thus, is also within the spirit of the present invention. The complete space of XML is a superset of FSML and only very specific forms of XML can function as an FSML. We shall show below that an XML functioning as a FSML, is also an FSML. The method of using a FSML to encode such algorithmic information is central to the method of practice for this invention. Hence, there are many ways to define a Markup Language (ML) with sufficient capacity to implement the functionality of a FSML and hence this invention. In essence, one can define a family of languages that all share the ability to encode algorithmic flow information as required by this invention—that is what we refer to as a FSML-capable language.

The FSML is itself a textual language that only encodes algorithmic flow and organization. A FSML is simpler than a typical programming language. It is much easier to construct a parsing tool for an FSML than a universal programming language since a universal programming language must account for data and memory allocation as well as control flow and data structure. A FSML is mainly concerned with control flow structure and partially concerned with data structure. Although a FSML may contain several specialized statements that code for certain algorithmic components representing control flow structure, a minimal FSML required to implement the features in the present invention will have a syntax that supports encoding of:

Function, or subroutine input and associated end, or exit points;

Logical branch, path and branch end points;

Iterative loop and loop end points;

Inline comments;

Procedural Scope;

One textual string parameter for each FSML statement;

One textual comment string for each FSML statement.

When practicing this invention a sequence of FSML statements, i.e., an FSML program, is used along with a sequence of text strings that represents some sequence of instructions in a conventional programming language. Each conventional programming language instruction is placed as a textual string parameter within each FSML statement. This effectively “encases,” or embeds a programming language source code within a FSML program.

Using a standard grammar and lexical pattern notation known as YACC grammar and Regular Expressions (See Reference “LEX & YACC,” O'Reilly & Associates, Inc., p51), we define the required FSML properties. We define a “minimal” non-XML compliant Flow Structure Markup Language. It is “minimal” in that it only defines the minimum set of expressions necessary to encode all types of flow structure information used by traditional source code languages. The basic grammar definition for a FSML, a Flow Structure Markup Language grammar follows as:

{// Grammar Rules for the Hierarchial Relationship of Flow Structure Objects: }

| | | |
|---|---|---|
| FSML_Program | −> | Element_List ; |

| | | |
|---|---|---|
| Element_list | −> | Element \| Element_List Element ; |

| | | |
|---|---|---|
| Element | −> | Module \| Iteration \| Logic \| Sequential_Step\| end ; |
| Module | −> | input end \| input Element_List; |
| Iteration | −> | loop lend \| loop Element_List lend ; |

| | | |
|---|---|---|
| Logic | −> | branch Path_List bend ; |
| Path_List | −> | Single_Path \| Path_List Single_Path |
| Single_Path | −> | path \| path Element_List ; |

| | | |
|---|---|---|
| Sequential_Step | −> | step ; |

{// The Elementary Flow Grammar Definitions in Terms of Related Terminal Tokens: }

| | | | |
|---|---|---|---|
| input −> | START_INPUT | TEXT_CODE | END_INPUT |
| ; | | | |
| end −> | START_END | TEXT_CODE | END_END ; |
| loop −> | START_LOOP | TEXT_CODE | END_LOOP ; |
| lend −> | START_LEND | TEXT_CODE | END_LEND ; |

| | | | |
|---|---|---|---|
| branch −> | START_BRANCH | TEXT_CODE | END_BRANCH ; |

| | | | |
|---|---|---|---|
| path −> | START_PATH | TEXT_CODE | END_PATH ; |
| bend −> | START_BEND | TEXT_CODE | END_BEND ; |

| | | | |
|---|---|---|---|
| step −> | START_PROCESS | TEXT_CODE | END_PROCESS \| |

| | | |
|---|---|---|
| START_EVENT | TEXT_CODE | END_EVENT |

|

| | | |
|---|---|---|
| START_CARIABLE | TEXT_CODE | END_CARIABLE \| |
| START_SET | TEXT_CODE | END_SET ; |

With regard to the Elementary Flow Grammar Definitions, specifically step, we have defined several possibilities, namely: PROCESS, EVENT, VARIABLE and SET. In this grammar, one may define additional types of elementary definitions without deviating from this invention. We show these four to illustrate the generality of the method and its ability to support all requirements for any type of algorithmic information using the relatively simple grammar definitions above. Similarly, the grammar definitions for other elementary objects (e.g. input, branch, etc.) can be extended without diverging from the spirit of the invention since the hierarchical grammar rules do not change.

Furthermore, the choice of names for each elementary type and any grammar object is arbitrary and does not impact the utility of this invention. Only the hierarchical grammatical structure and the methods taught herein for using such a grammar and resulting language to create significantly enhanced software development tools centers on the core methods and practice of this invention. Hence, any grammar that simulates or encompasses the rules above in such a way as to apply a Markup Language (ML) to enable generalized flowcharting and flow analysis of text-reducible process information is within the spirit of this invention.

To complete the above language definition, we must define the ‘Terminal Symbols’ or tokens referenced above. We do this using the regular expression notation in Table 1, below. (See Reference “LEX & YACC,” O'Reilly & Associates, Inc. p28 for a description of regular expression symbols)

TABLE 1
The Lexical Definition for a non-XML compliant Flow Language using
Regular Expression Notation.

| | | |
|---|---|---|
| Flow Token | Regular Expression | Description |

| | | |
|---|---|---|
| TEXT_CODE | (\hat{ }FLOW_START\|.)* | Matches any text, even null |
| | | text, expect new lines and |
| | | FLOW_START |
| FLOW_START | START_INPUT\|START_END\| | Matches any of the START_tokens |
| | START_LOOP\|START_LEND\| | |
| | START_BRANCH\|START_PATH\| | |
| | START_OUTPUT\| | |
| | START_VARIABLE\| | |
| | START_PROCESS\|START_SET | |
| START_COMMENT | \/\/ | Similar to standard C++ inline |
| | | comments e.g. // |
| END_COMMENT | \n | New Line |
| INLINE_COMMENT | (START_COMMENT)TEXT_CODE | |
| | (END_COMMENT) | |
| START_INPUT | \hat{ } *input *\( | Begins a line with input ( |
| END_INPUT | \);INLINE_COMMENT | e.g.: );// . . . \n |
| START_END | \hat{ } *end *\( | |
| END_END | \);INLINE_COMMENT | |
| START_LOOP | \hat{ } *loop *\( | |
| END_LOOP | \);INLINE_COMMENT | |
| START_LEND | \hat{ } *lend *\( | |
| END_LEND | \);INLINE_COMMENT | |
| START_BRANCH | \hat{ } *branch *\( | |
| END_BRANCH | \);INLINE_COMMENT | |
| START_PATH | \hat{ } *path *\( | |
| END_PATH | \);INLINE_COMMENT | |
| START_BEND | \hat{ } *bend *\( | |
| END_BEND | \);INLINE_COMMENT | |
| START_PROCESS | \hat{ } *process *\( | |
| END_PROCESS | \);INLINE_COMMENT | |
| START_EVENT | \hat{ } *event *\( | |
| END_EVENT | \);INLINE_COMMENT | |
| START_VARIABLE | \hat{ } *define *\( | |
| END_VARIABLE | \);INLINE_COMMENT | |
| START_SET | \hat{ } *set *\( | |
| END_SET | \);INLINE_COMMENT | |

Although our original FSML is non-XML compliant, a similar XML compliant version for an equivalent FSML can easily be defined that in no way departs from the spirit of this invention. It is well known that the grammar of a language uniquely determines the language's functionality. By defining an XML-compliant FSML that uses the same flow grammar defined above, we prove that this new XML compliant FSML definition will also have the exact same functionality as our original non-XML compliant FSML and therefore is within the spirit, and scope, of this invention, the methods taught herein, and its claims.

Table 2, below shows the Lexical definitions that when used in place of Table 1 above, and using the flow grammar defined above, uniquely define an XML compliant version of our FSML. The original hierarchical grammar definition shared by both implementations of these Flow Structure Markup Languages (FSMLs) means that they have the exact same functionality. The way we employ this functionality to produce language-independent flowchart programming and analysis tools is the central core of this invention, its methods and its claims.

TABLE 2

| Flow Token | Regular Expression | Description |
|---|---|---|
| TEXT_CODE | (\hat{ }FLOW_START\|\n\|.)* | Matches any text including new |
| | | lines but not the |
| | | FLOW_START tokens |
| FLOW_STARTR | START_INPUT\|START_END\| | Matches any of the START_tokens |
| | START_LOOP\|START_LEND\| | |
| | START_BRANCH\|START_PATH\| | |
| | START_OUTPUT\| | |
| | START_VARIABLE\| | |
| | START_PROCESS\|START_SET | |
| START_COMMENT | <comment> | <comment> |
| END_COMMENT | <\/comment> | </comment> |
| INLINE_COMMENT | (START_COMMENT)TEXT_CODE | Can be a valid tagged comment, |
| | (END_COMMENT)\|() | or can be an empty or null |
| | | string |
| START_INPUT | <input> | Start input tag: <input> |
| END_INPUT | <\/input>INLINE_COMMENT | End input tag with a training |
| | | comment or null comment e.g.: |
| | | </input> |
| | | or, |
| | | </input><comment>. . .</comment> |
| START_END | <end> | |
| END_END | <\/end>INLINE_COMMENT | |
| START_LOOP | <loop> | |
| END_LOOP | <\/loop>INLINE_COMMENT | |
| START_LEND | <lend> | |
| END_LEND | <\/lend>INLINE_COMMENT | |
| START_BRANCH | <branch> | |
| END_BRANCH | <\/branch>INLINE_COMMENT | |
| START_PATH | <path> | |
| END_PATH | <\/path>INLINE_COMMENT | |
| START_BEND | <bend> | |
| END_BEND | <\/bend>INLINE_COMMENT | |
| START_PROCESS | <process> | |
| END_PROCESS | <\/process>INLINE_COMMENT | |
| START_EVENT | <event> | |
| END_EVENT | <\/event>INLINE_COMMENT | |
| START_VARIABLE | <define> | |
| END_VARIABLE | <\/define>INLINE_COMMENT | |
| START_SET | <set> | |
| END_SET | <\/set>INLINE_COMMENT | |

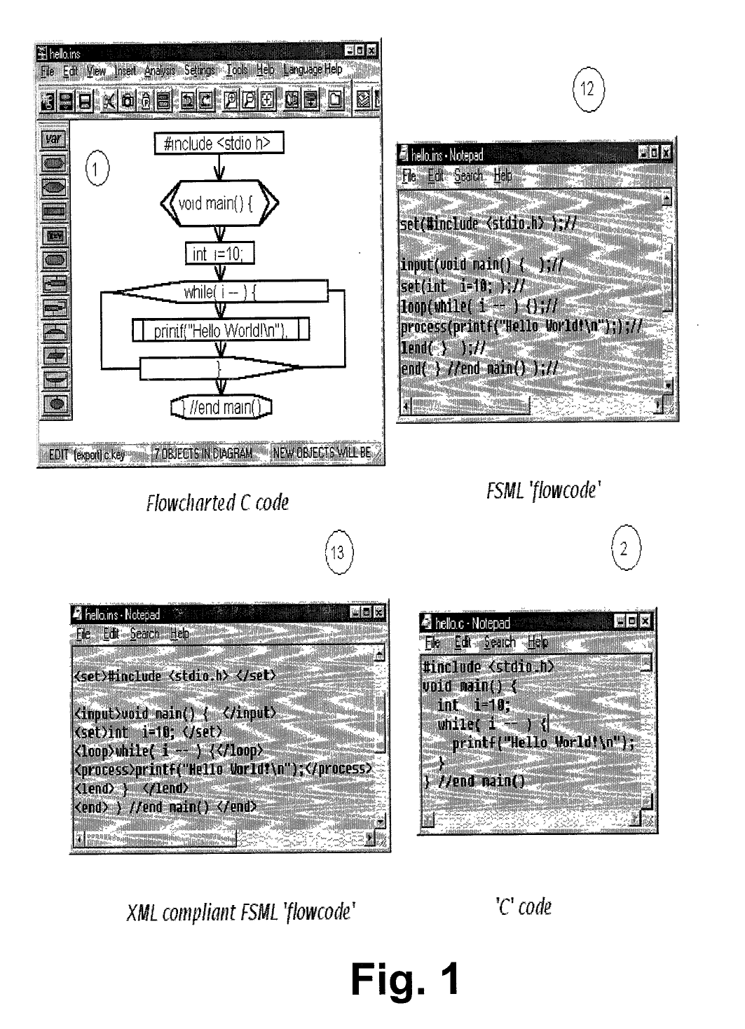

The preferred embodiment will utilize a FSML to encode algorithmic and structural information along with textual source code. In this embodiment, each statement in the FSML code has a one-to-one correspondence with a line of textual code or an individual source code instruction. This correspondence between the flowchart, the FSML, and the source code is illustrated in FIG. 1 with a simple C program. With reference to FIG. 1, a graphical flowcode view 1 is shown with its equivalent textual flowcode file 12, an equivalent XML-compliant flowcode text 13, and the original standard C source code file 2. The FSML's main function is to encode the parts of the algorithmic structure that are language-independent and can be used to draw a flowchart, support language independent methods for implementing flow analysis metrics and enable advanced code search engines.

The FSML is read and parsed by a rendering module that display's each FSML-encoded statement as a flowchart block on the computer display. The FSML's enclosed text code parameter will typically be a line of code, i.e. a single instruction, in the target language—although empty FSML statements and flowchart blocks are allowed. If an FSML text parameter is present, it can be displayed as a line of code within a flowchart block. Each FSML statement can also have an optional line of comment information associated with it. The said line of FSML comment information can optionally be displayed, and/or used to encode extended display formatting (e.g. color) and/or encode hyper-link information related to the corresponding line of FSML code that is drawn as a flowchart block.

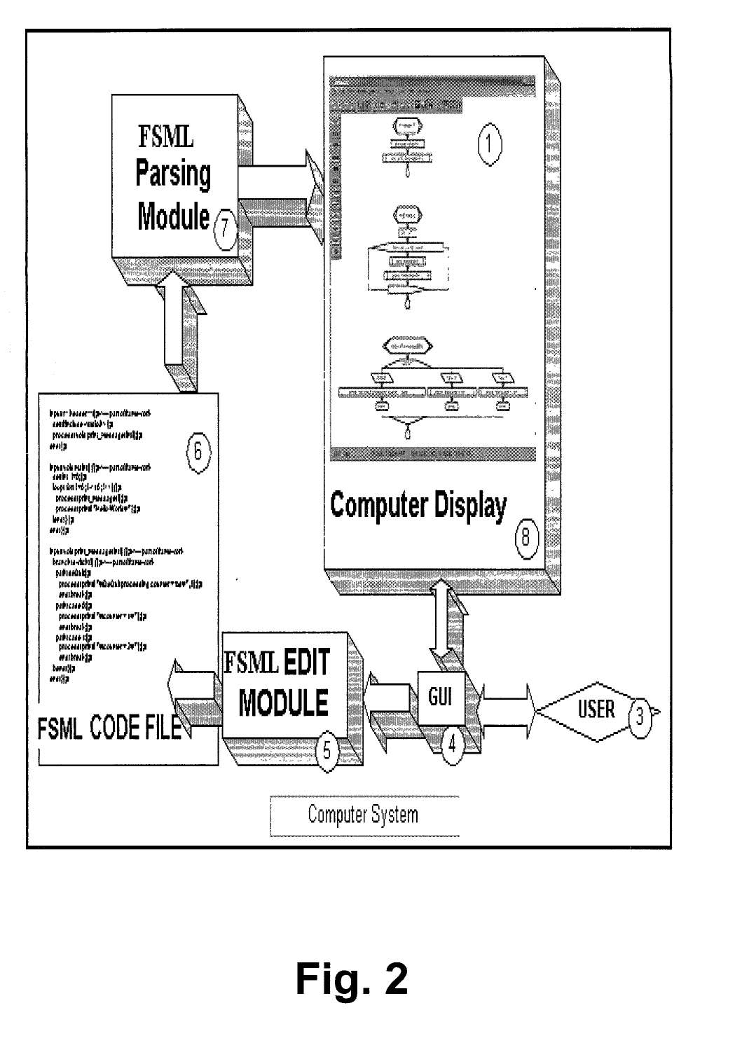

Pursuant to the present invention, and in reference to FIG. 2, the preferred embodiment is implemented on a computer system equipped with a Graphical User Interface (GUI) 4 that may consist of a human-computer interface device(s) (e.g. keyboard, pointing device, voice recognition commands, etc.) and a graphical display system 8, to support editing and display of computer graphics. Those skilled in the art will realize that the present invention is not limited to any particular type of computer or memory device for performing these functions. It should also be noted that the term “computer”, as that term is used herein, is intended to denote any machine capable of performing the calculations, or computations, necessary to perform the tasks of the present invention. In essence, this includes any machine that is capable of accepting a structured input and of processing the input in accordance with prescribed rules to produce an output. Furthermore, those skilled in the art will understand that the system shown in FIG. 2 may be implemented in hardware, software, or a combination of both, and is not limited to any particular physical, structural, or electrical configuration.

Editing the visual flowchart of the code, or flowcode file 1, is accomplished via the GUI 4. The user 3 selects one or more flowchart blocks and performs an edit command on the selected block(s). Since, each flowchart block has a one-to-one correspondence with an FSML statement, the FSML edit module 5, transparently applies the desired edit command, e.g., cut, copy, paste, change text line, to the corresponding textual statements of the FSML code 6. The memory occupied by the graphical flowchart previous to the edit command is released. The new FSML code 6, is then parsed by a Parsing Module 7, to regenerate a new diagram, stored in memory, and displayed on the display device 8. Viewing the FSML text code 6, as editing occurs is not required by the user. The user only performs GUI-based editing of the graphical, flowchart representation of the embedded textual code—the flowcode 1. The basic process for editing an FSML as a graphical flowchart is summarized below:

Initially, a file of FSML code is opened, read and parsed to generate a diagram of the encoded algorithmic flow. The FSML flow is displayed as a flowchart while any text code parameters within the FSML are displayed within each corresponding flowchart block.

The user, via the computer's GUI system, graphically selects one or more flowchart blocks and indicates an edit action.

The editing module then determines the corresponding changes to be made to the FSML text code and makes them.

The old flowchart diagram's memory is released and is erased from the computer display.

The new FSML code is parsed and a new diagram is generated in memory and on the computer's display that replaces the old flowchart diagram.

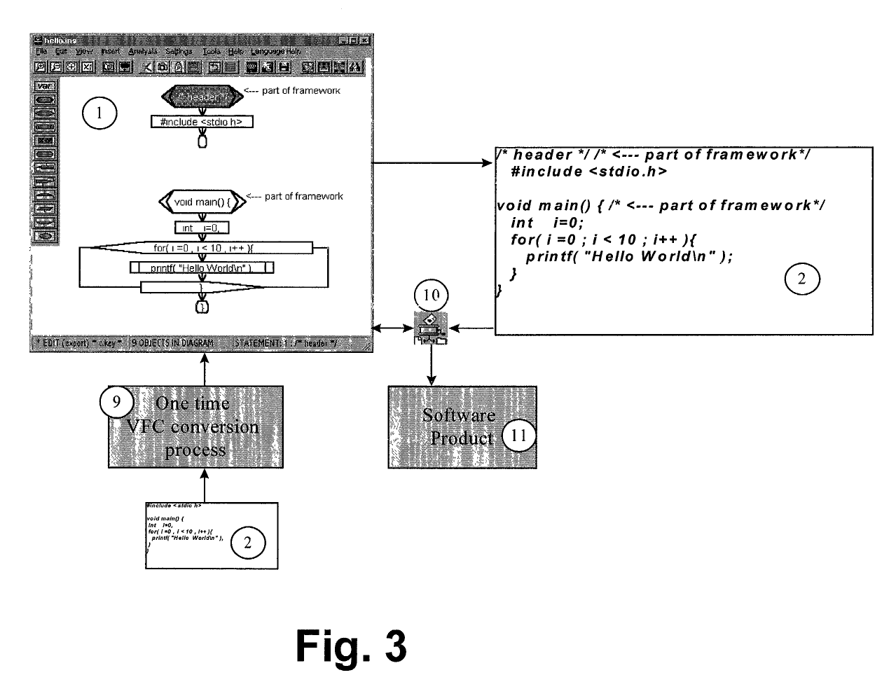

The preferred embodiment provides an Integrated Development Environment (IDE) similar to the current state of the art, with the distinct difference of editing all textual code graphically as flowcharts. FIG. 3 illustrates the typical use of the present invention where the initial textual code 2 is converted into flowcode using a conversion means related to the present invention 9, then viewed and manipulated by an apparatus that implements the present invention to apply modifications. Furthermore, textual code 2 can be output, transparently to the user, in order to process the text code with a language based software development tool 10. This may result in the creation of software product 11. Equally applicable is the case wherein the new code is initially created as flowcode, hence the one-time conversion 9 is not needed. Additionally, the said invention can replace the need for a program code text editor. The exported source code text file is then considered an intermediate file to the flowcode file, much like assembler and object files are currently considered intermediate files generated from text code files.

Conversion of code to flowcode is a one time process and also comprises a method of the present invention. Said conversions are accomplished by a language-dependent program, or program module, that reads the input language text and parses it to determine the intended algorithmic flow. The conversion program using an FSML to produce a flowcode file then recombines the algorithmic flow information. The actual mapping of FSML statements to a particular textual code is determined by the algorithmic intent and details of the text language to be “flowcoded.” The choice of FSML statements to text code mapping is not an expressly critical factor for the operation of the system, although the most efficient gains from the present invention are realized when the procedural flow statements in a text language are mapped to the corresponding flow statements in the FSML. When an algorithm in some text language uses a consistent FSML mapping to its logical, iterative, and function entry/exit points, the present invention provides an efficient apparatus for automatically drawing and editing a visual flowchart of the said textual algorithm. A procedural description in textual code that has been accurately encased within the parameters of a sequence of FSML statements contains both the algorithmic and the language-specific implementation details in a single FSML code, or flowcoded, file.

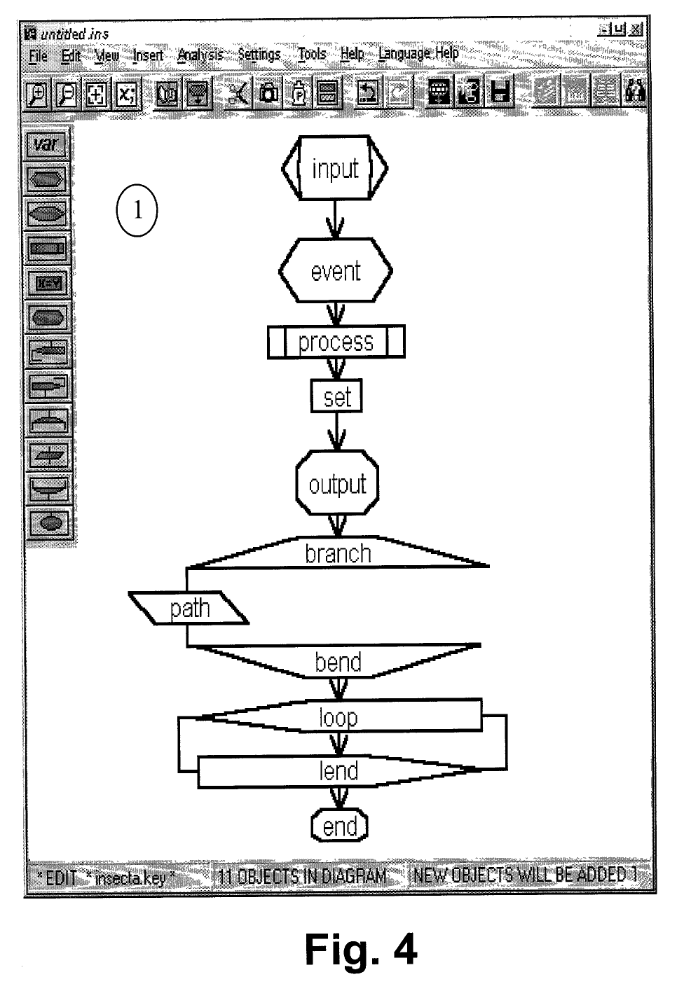

In accordance with the preferred embodiment of the present invention, a sequentially organized plurality of FSML statements are represented as a series of connected, and unconnected, flowchart blocks that represent an algorithmic sequence, or set of sequences. In order to graphically provide sufficient information on the computer display, a compact flowcharting notation is used in the preferred embodiment of the invention. Statements of the FSML and the corresponding flowchart symbols are shown in FIG. 4. The precise visual representation of the flowchart is not a critical factor in the present invention. Any procedural flowchart blocks can be used without departing from the spirit of the invention, so long as they represent procedural flow. Furthermore, an alternate embodiment of the invention allows the user to specify the visual attributes of the procedural flowchart blocks.

Another feature of the invention uses an FSML with inline comments and a means to swap the FSML comment and the FSML parameter. This feature allows the juxtaposition between a single line of code and an alternate line of code held within the inline comments. This embodiment offers a ‘duality’ of text within each flowcode statement for simplified translation, debugging, and editing of computer languages.

Several embodiments of the present invention are possible wherein the algorithmic information is encoded both textually and visually for the purpose of graphically manipulating the textual code. It should also be noted that those skilled in the art could make modifications without departing from the invention principles herein discussed. Given adherence to the foregoing FSML grammar rules, the choice of exact FSML syntax and additions that enable extensions to describe non-sequential algorithms and data structures can be made. In addition the foregoing discussion, with respect to the embodiments that use a FSML, an equivalent embodiment may “instrument” the text code wherein the same algorithmic information encapsulated by the FSML is placed within the textual code file as inline comments. Various embodiments of the present invention, as noted above, can also be combined. Therefore, these appended claims are intended to cover all such aspects and modifications that fall within the spirit of the invention.

What is claimed is:

1. An apparatus that develops an algorithmic representation based on a textual source code, comprising:
first logic, the first logic deriving algorithmic flow information from the textual source code; and
second logic, the second logic using hierarchical Flow Structure Markup Language grammar to encode the algorithmic flow information and the textual source code to create the algorithmic representation.

2. The apparatus of claim 1, wherein the algorithmic representation is viewable as a flowchart and wherein the flowchart can be graphically edited.

3. The apparatus of claim 1, wherein the Flow Structure Markup Language grammar is Extended Markup Language (XML)-complaint Flow Structure Markup Language grammar.

4. The apparatus of claim 1, wherein the Flow Structure Markup Language grammar is non-XML-complaint Flow Structure Markup Language grammar.

5. The apparatus of claim 2, wherein editing the flowchart results in the textual source code being automatically edited.

6. A method for developing an algorithmic representation based on a textual source code, the method comprising the steps of:
deriving algorithmic flow information from the textual source code; and
using hierarchical Flow Structure Markup Language grammar to encode the textual source code and the algorithmic flow information to create the algorithmic representation.

7. The method of claim 6, wherein the algorithmic representation is viewable as a flowchart, wherein the flowchart can be graphically edited.

8. The method of claim 6, wherein the Flow Structure Markup Language grammar is XML-complaint Flow Structure Markup Language grammar.

9. The method of claim 6, wherein the Flow Structure Markup Language grammar is non-XML-complaint Flow Structure Markup Language grammar.

10. The method of claim 7, wherein the textual source code is edited based on the edit of the flowchart.

11. A computer program for developing an algorithmic representation based on a textual source code, the computer program being embodied on a computer-readable medium, the computer program comprising:
a first logic, the first logic deriving algorithmic flow information from the textual source code; and
a second logic, the second logic using hierarchical Flow Structure Markup Language grammar to encode the textual source code and the algorithmic flow information to create the algorithmic representation.

12. The computer program of claim 11, wherein the algorithmic representation is viewable as a flowchart, wherein the flowchart can be graphically edited by an editing logic.

13. The computer program of claim 11, wherein the Flow Structure Markup Language grammar is XML-complaint Flow Structure Markup Language grammar.

14. The computer program of claim 11, wherein the Flow Structure Markup Language grammar is non-XML-complaint Flow Structure Markup Language grammar.

15. The computer program of claim 12, wherein a second editing logic edits the textual source code based on the editing of the flowchart.

16. A means for developing an algorithmic representation based on a textual source code, comprising:
deriving algorithmic flow information from the textual source code; and
using hierarchical Flow Structure Markup Language grammar to encode the textual source code and the algorithmic flow information to create the algorithmic representation.

17. The means of claim 16, wherein the algorithmic representation is viewable as a flowchart, wherein the flowchart can be graphically edited.

18. The means of claim 16, wherein the Flow Structure Markup Language grammar is XML-complaint Flow Structure Markup Language grammar.

19. The means of claim 16, wherein the Flow Structure Markup Language grammar is non-XML-complaint Flow Structure Markup Language grammar.

20. The means of claim 17, wherein the editing of the flowchart automatically edits the textual source code.
